(19) United States
(12) Patent Application Publication
(10) Pub. No.: US 2013/0220454 A1
(43) Pub. Date: Aug. 29, 2013

(54) POSITION-ADJUSTABLE GAS REGULATOR

(71) Applicant: Jeff Schreiber, Grayslake, IL (US)

(72) Inventor: Jeff Schreiber, Grayslake, IL (US)

(73) Assignee: Pressure Specialist Inc., Crystal Lake, IL (US)

(21) Appl. No.: 13/438,672

(22) Filed: Apr. 3, 2012

Related U.S. Application Data
(60) Provisional application No. 61/603,757, filed on Feb. 27, 2012.

(51) Int. Cl. F16K 31/36

(52) U.S. Cl. 137/505

(57) ABSTRACT

A pressure regulator for controlling the flow of gas from a high pressure source to a low pressure device includes a body having a high pressure inlet defining a seat. An adjusting collar has a centrally located bore. The collar engages the body at any predefined radial orientation. The collar has a thread and is securable to the body at the selected radial orientation. The regulator also has a threaded bonnet to engage the collar. A locking ring engages the body and secures the adjusting collar to the body. A piston has a central bore and is disposed within a piston chamber that defines a gap between the piston and a wall. The piston is movable between an open condition and a closed condition. A spring moves the piston to the open condition. A pin valve is disposed in the central longitudinal bore in the piston.

### CROSS-REFERENCE TO RELATED APPLICATION DATA

This application claims the benefit of priority of Provisional U.S. Patent Application Ser. No. 61/603,757, filed Feb. 27, 2012, the disclosure of which is incorporated herein by reference in its entirety.

### BACKGROUND OF THE INVENTION

The present invention is directed to a novel adjustable locking collar for use on a pressure regulator. More particularly, the present invention relates to an adjustable locking collar that engages both the main body and the bonnet of a pressure regulator for use in paint ball guns that use compressed gas to fire projectiles. The present invention is also adapted for use with other pressurized gas devices.

Sporting events that provide the participant with an adventure in military strategy and the feel of the fear and exhilaration of battle have become very popular. Generally participants are equipped with a gas projectile gun or rifle and protective gear, and are divided into two or more combat groups each with the goal of surviving the others.

One such sporting event is commonly referred to as “paintball”. In this event, participants fire paint-filled projectile balls at one another. In a typical paintball event, participants fire projectiles, or paintballs, at one another and, when struck, are “painted” by the paint ball. The objective of such an event is to be the last person that has not been “painted” or hit with a projectile.

Typically, the projectiles used in these events are propelled, using a compressed gas to avoid the potential dangers of explosives such as gun powder. The dangers of explosives include not only the physical danger of the explosion but also the increased speed that such explosions impart to projectiles. Moreover, compressed gas is less costly than explosives and is readily obtainable.

When these types of systems are used, compressed gas is provided or supplied from a high-pressure source carried by the participant in a gas bottle or tank. Although high-pressure gas is needed at the gun firing mechanism to propel the paint balls, typically the pressure in these tanks is greater than the pressure needed to safely propel the projectile within the parameters of the game. As such, it is necessary to regulate the pressure of the compressed gas provided to the gun firing mechanism to allow projectiles to be launched at a safer velocity and prevent damage to the gun. Typically, a regulator is provided, mounted to the gun and is carried by the game participant.

Known pressure regulators generally include a main body, a biased piston, and a bonnet. The main body generally has several projections extending outwardly from the body, these include: a set of burst discs: a high pressure over pressurization device and a regulated pressure over pressurization device; a pressure gauge; and a fill nipple. The body and the bonnet threadedly engage to form a single regulator unit. To safely use the regulator unit the bonnet and the main body must be fully engaged with one another, with the gun, and with the tank. In a typical mounting arrangement, the high pressure end of the regulator is threaded onto the tank and the low pressure end of the regulator is threaded onto a female receiver on the gun. Since the tank and regulator and the regulator and gun threads must be fully engaged, there is no way in which the radial orientation of the regulator can be adjusted once the components are threaded together or engaged.

In this fully engaged position, however, the projections included along the exterior of the main body can impinge upon the user's arm and cause discomfort. In addition, users may not have the ability to quickly view the pressure gauge to determine system pressure, all of which can interfere with the user's experience.

Accordingly, there exists a need to manipulate the body or bonnet of the regulator unit to prevent the components from interfering with the user and/or to allow for viewing the regulator pressure gauge, thus enhancing the user's experience while at the same time not compromising the safety, weight, and size of the regulator.

### BRIEF SUMMARY

A pressure regulator controls the flow of a gas from a high pressure source to a low pressure device. Gas is delivered from the regulator at a predetermined outlet pressure. A typical regulator has a set of (two) burst discs, a fill nipple valve, and a pressure gauge extending outwardly from the main body of the regulator. To operate safely and properly, the components that make up the regulator unit must be fully threadedly engaged to form a single sealed unit. It will be appreciated that the threaded connections terminate wherever the thread bottoms out against its mating thread. In this fully engaged position, the user is not able to radially vary the position of the dual burst disks, pressure gauge, and fill nipple. In these immoveable positions the profiles of the components interfere or impinge upon the user's wrist and arm and also interfere with the user's ability to effectively read the pressure gauge.

The present regulator contains an adjustable and lightweight adjusting collar that engages the main body, the bonnet, and a locking ring that provides a quick and effective means of adjusting the position of the outwardly extending projections without compromising the safety of the regulator (e.g., sealing all of the threads to one another). The adjusting collar adds the ability to quickly adjust the location of the projections relative to the main body of the regulator, while adding negligible weight to the highly accurate pressure regulating device.

The regulator includes a body having a high pressure inlet and defining a seat. Preferably, the seat is conical. A bonnet is engageable with the body to define a piston chamber within the body and the bonnet. The bonnet has a regulated gas outlet.

The main body of the regulator has a high pressure inlet port that threadedly engages the gas cylinder. The inlet port travels through the main body of the regulator and opens into a plug chamber. The plug chamber is preferably conical. A guide sleeve is formed in the body and extends from about the plug chamber. The guide sleeve has an inner and outer wall. The outer wall of the guide sleeve has a diameter less than the diameter of the main body. The outer wall of the guide sleeve has a groove or channel continuously running around its perimeter proximate the main body. The outer wall of the guide sleeve has a second groove or channel continuously around its perimeter, the second groove or channel distal the main body.

The collar fits over the outer wall of the plug chamber and engages the main body. The collar has an outer diameter complimentary to the diameter of the main body and a threaded end that threadedly engages the interior wall of the bonnet. The threaded end has a diameter less than the diameter of the main body. The collar fits over the outer wall of the guide sleeve and can be radially and longitudinally positioned and subsequently secured into place using a series of fasteners.

The locking ring is made of a lightweight metal or alloy and is helical in shape. The locking ring engages a channel continuously around the perimeter of the guide sleeve. In use the adjusting collar is positioned over the guide sleeve of the main body. The locking ring is then placed within and around the channel of the guide sleeve. The bonnet is then threaded with the adjusting collar.

A present regulator includes a first seal disposed between the plug and the piston chamber and a second seal disposed between the impingement surface and the piston chamber. The piston includes a shoulder for engaging a stop surface within the bonnet to define the open regulator condition. The shoulder is disposed between the first and second seals.

To maintain the regulator as a compact, efficient unit, the high pressure inlet and the regulated gas outlet are collinear with one another.

These and other features and advantages of the present invention will be apparent from the following detailed description, in conjunction with the appended claims.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIG. 1 is a cross-sectional view of one embodiment of a position-adjustable gas regulator embodying the principles of the present invention, the regulator being shown in the open condition;

FIG. 2 is a cross-sectional view of an alternate embodiment the regulator shown in the open condition; and

FIG. 3 is a cross-sectional view of an alternate embodiment of the direct acting gas regulator.

### DETAILED DESCRIPTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

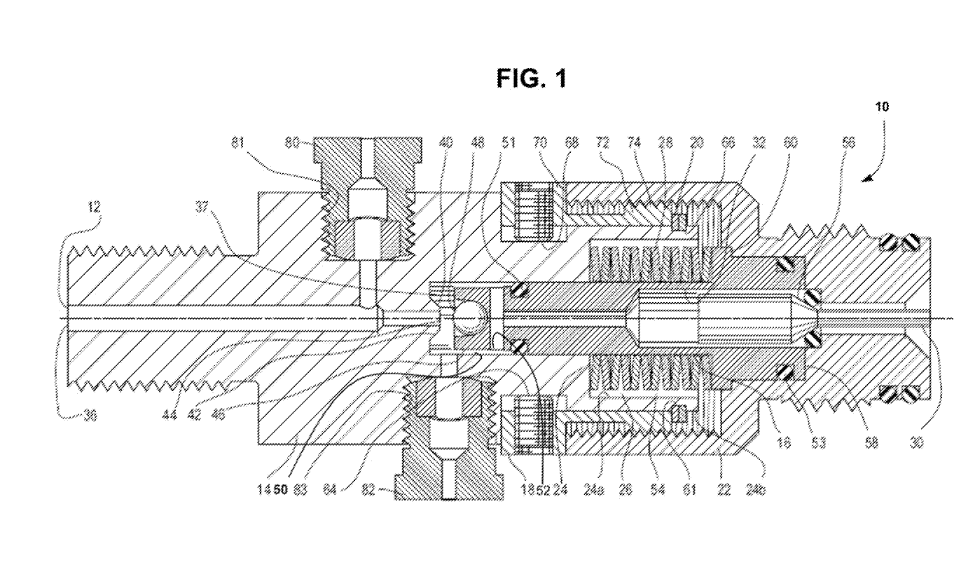

Referring to the figures and briefly to FIG. 1, a present regulator 10 is shown in the open condition such that a regulated flow path, indicated generally at 12, is provided from a high pressure gas source to a downstream device such as a paint ball gun or the like. The controlled downstream pressure is regulated essentially regardless of the higher upstream pressure. An exemplary regulator is disclosed in Carroll, U.S. Pat. No. 6,851,447, which is commonly assigned with the present application, and the disclosure of which is incorporated herein by reference.

The regulator 10 includes generally, a main body 14, a biased piston assembly 16, an adjusting collar 18, a locking ring 20, and a bonnet 22. As will be discussed in more detail below, the body 14 and the collar 18 engage by the collar sliding over and around the guide sleeve 24. The bonnet 22 and collar 18 threadedly engage and together with the body 14, seal the regulator 10 as a unit. A piston chamber 26 is defined within the sealed together body 14, bonnet 22, and collar 18, and the piston assembly 16 is disposed within the chamber 26. Spring washers (Belleville springs) 28 are disposed about the piston assembly 16, between the piston 16 and the body 14, to bias the piston 16 (and the regulator 10) to the open condition.

A pin valve 30 is disposed within a central, longitudinal bore, indicated generally at 32 in the piston assembly 16. The pin valve 30, which will be recognized by those skilled in the art, provides a sealable flow path from the regulator 10 to the downstream device. The pin valve 30 is maintained within the piston bore 34 by a spring (not shown) to bias the pin valve 30 closed. The pin valve 30 permits removing or separating the regulator 10 from the downstream device (e.g., the paint ball gun) without loss of gas pressure.

Gas flows into the regulator 10 through a high pressure inlet port 36 at the body side 14 of the regulator 10. The inlet port 36 opens into a plug chamber 37. A seat 40 defines the entry into the plug chamber 37. The seat 40 can be formed having a generally conical shape with angled or inclined sides 42 terminating at a flat or relatively flat end 44.

The plug chamber 37 is configured to accommodate a plug portion 46 of the piston 16. The plug portion 46 is formed at an end of the piston 16 and serves as a support for a sealing ball 48 within an end of the plug 46. The sealing ball 48 can be formed from a resilient material such as urethane or the like to form a gas-tight seal when the ball 46 is seated on the seat 40.

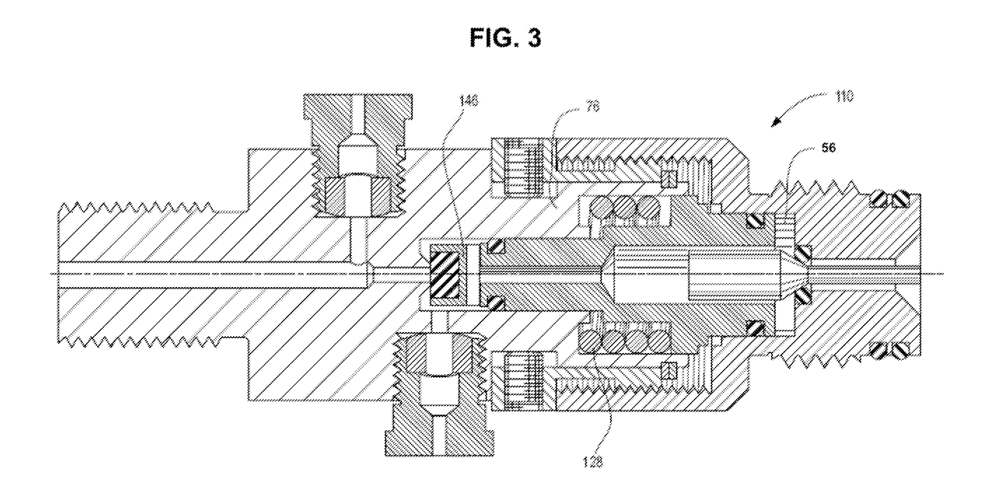

The plug 46 and plug chamber 37 are dimensioned and configured such that a gap, indicated generally at 50, is defined between the plug 46 and the chamber 37 wall. The gap 50 defines a portion of the flow path 12. Openings 52 (FIG. 3) are formed in the sides of the plug 46 that provide a flow path into the center (e.g., central bore 32) of the piston 16. In this manner, when the piston 16 is moved away from the seat 40 (when the ball 36 is disengaged from the seat 32), the flow path is established through the seat 40, around the plug 46, into the openings 52 and into the piston central bore 32. A seal 51, such as a neoprene O-ring, is positioned on the piston 16 between the piston 16 and the wall that defines the plug chamber 37. In this manner, gas is precluded from flowing in to the piston chamber 26 from around the plug 46.

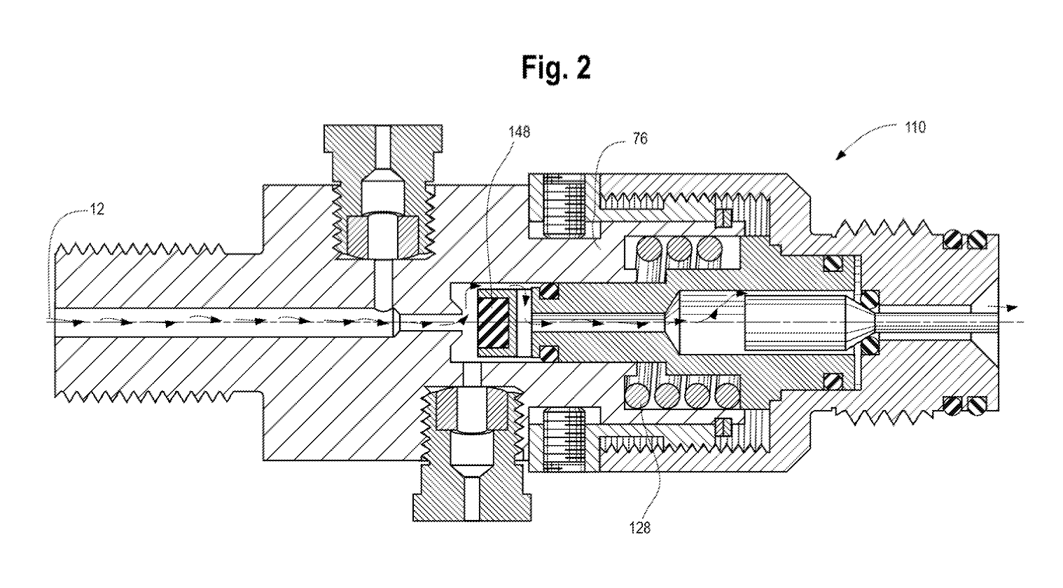

The regulator 10 includes a low pressure region indicated generally at 54 in FIG. 2, (within the piston chamber 26) and a regulated pressure region, indicated generally at 56 in FIGS. 2 and 3, separated from the low pressure region 54 by the plug seal 51 and a piston seal 53 at an opposing end of the piston 16. The regulated pressure region 56 includes an impingement surface 58 against which the (pressure) regulated gas exerts a force for moving the piston 16 to the closed position. The piston 16 includes a shoulder 60 that engages a stop surface 61 within the bonnet 22 to prevent the piston 16 from moving beyond the open condition.

A guide sleeve 24 is formed in the body 14 that extends into the piston chamber 26 from about the plug chamber 37. The sleeve 24 has an inner wall 24a and an outer wall 24b. The outer wall 24b of the guide sleeve has a diameter less than the diameter of the main body 14. The outer wall 24b has a first groove or channel 24 continuously running around its perimeter at the body side 14. The outer wall 24b has a second groove or channel 66 continuously around its perimeter, the second groove 66 being farther from the body side 14. The sleeve 24 defines a guide for movement of the piston 16 toward and away from the seat 40 and near a free end 74 of the sleeve 24 and further provides a surface against which the seal 51 acts.

The adjusting collar 18 has a circumferentially extending ring 70, an intermediate portion extending longitudinally from the ring 72, and a threaded free end 74. The collar 15 has a centrally located bore 76, shown generally, that allows the collar 18 to fit over the guide sleeve outer wall 24b. The collar 18 is positioned over the guide sleeve 24 and rests against the main body 14 with the threaded free end 74 sitting below the second groove 66. The collar 18 can include one or more set screws 68 that pass through the ring, which, when tightened, pass through the ring and engage the outer wall of the guide sleeve 24b at the first groove 64 to lock the collar 15 onto the main body at a desired radial position. The threaded free end 74 threadedly engages the bonnet 22.

The locking ring 20 can be made of a lightweight metal or alloy, preferably a spring metal (such as spring steel) and can have a compressed helical shape, much like a split key ring. A preferred locking ring 20 has a square or rectangular cross-section. The locking ring 20 is positioned in the second groove of the guide sleeve 66. The locking ring 20 has an outer diameter, when set in the groove 66 that is greater than the inner diameter of the adjusting collar 18. As such, when the collar 18 is positioned on the sleeve 24 and the locking ring 20 is in place in the groove 66, the adjusting collar 18 is secured in a longitudinal position on the sleeve 24 and cannot be removed (without first removing the locking ring 20). In this manner, the adjusting collar 18 essentially becomes an extension of (albeit radially positionally adjustable vis-á-vis) the threading of the main body 14.

A typical regulator 10 includes a high pressure over pressurization device 80 and a regulated pressure over pressurization device 82, such as the illustrated, exemplary high pressure and regulated pressure burst disks, as well as a fill nipple (not shown) and a pressure gauge (not shown) and their respective ports which extend 90 degrees to the burst disk ports, (ports 81 and 83 being shown, the other ports are at 90 degrees to the illustrated ports 81, 83 or into and out of the page as viewed in FIG. 1). Unlike the burst disks which have a relatively low profile, the fill nipple and pressure gauge have a high profile (they extend outwardly from the body farther than the burst disks). In addition, users of paintball guns will often want to be able to view the pressure gauge to determine, approximately, the volume of gas remaining in the system for play.

It will be appreciated that the threaded connections terminate wherever the thread bottoms out against its mating thread. Additionally, bottoming out will occur at different radial positions with different components (e.g., different receivers or different regulators). As such, the radial position of, for example, the pressure gauge, is dependent upon where the regulator thread bottoms out in the receiver.

The present collar 18 permits radially adjusting the body 14 relative to the bonnet 22 so that the various attachments can be radially located as desired. With the tank (not shown) empty, the assembled regulator 10 (the set screws 68 tightened to secure the adjusting collar 18 to the main body 14), is threaded onto the gun and the tank onto the regulator. The bonnet 22 is also threadedly secured to the adjusting collar 18. The set screws 68 can then be loosened and the main body 14 rotated within the adjusting collar 18 to the desired radial position. Once the desired position is selected, the set screws 68 can be retightened onto the main body 14, so that the main body 14, adjusting collar 18 and bonnet 22 are fixed in position relative to one another. The tank and regulator can then be removed from the gun and the tank filled (through the fill nipple). When the regulator 10 is then reinstalled on the gun, the regulator 10 will seat at the previously selected radial position.

The adjusting collar 18 can be formed from a wide variety of materials, including steel, alloys and the like. Although set screws 68 are shown and described, those skilled in the art will recognize that the manner in which the adjusting collar is secured to the main body can vary, and that such various locking elements are within the scope and spirit of the present disclosure.

Referring briefly now to FIG. 2 and FIG. 3, there is shown an alternate embodiment of the regulator 110. This embodiment is similar to the embodiment 10 illustrated in FIG. 1, except for the main spring 128 and plug 146. As is shown in FIG. 2 and FIG. 3, in these embodiments, a coil spring 128 is used in lieu of spring washers 28. In addition, a disk 148 formed from nylon or another resilient material is used in place of the ball 48. The remaining portions of the regulator are identical or similar to that of the previous embodiment 10.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. A pressure regulator for controlling the flow of gas from a high pressure source to a low pressure device, comprising:
a body having a high pressure inlet defining a seat;
an adjusting collar having a centrally located bore, the collar engaging the body at any selected radial orientation, the adjusting collar having an adjusting collar thread thereon and securable to the body at the selected radial orientation, and at a fixed longitudinal location;
a plurality of fasteners for securing the adjusting collar to the body at the selected radial orientation, wherein the plurality of fasteners impart a radial force to secure the adjusting collar to the body;
a bonnet having a thread therein, wherein the bonnet thread engages the adjusting collar thread;
a piston having a central bore in a longitudinal direction that is disposed within a piston chamber, the piston chamber defining a gap between the piston and a wall wherein the piston is movable between an open condition and a closed condition;
a spring configured to move the piston to the open condition; and
a pin valve disposed within the central longitudinal bore in the piston.

2. The pressure regulator in accordance with claim 1 wherein the piston is movable between the open condition and the closed condition;
the piston includes a plug having a sealing element with a sealing surface, and the seat is configured to close a flow path through the regulator in the closed condition, and to open the flow path through the regulator in the open condition;
the plug includes radially disposed openings therein for communicating gas from around the plug to the central longitudinal bore in the piston;
the piston includes an impingement surface in flow communication with the central bore such that gas pressure on the impingement surface exerts a force on the piston to move the piston to the closed condition.

3. (canceled)

4. The pressure regulator in accordance with claim 3 wherein the fasteners are locking screws.

5. The pressure regulator in accordance with claim 1 including a guide sleeve formed as part of the body and configured for receiving a portion of the piston.

6. The pressure regulator in accordance with claim 5 wherein the guide sleeve has an outer wall.

7. The pressure regulator in accordance with claim 6 wherein the outer wall has a first channel formed therein.

8. The pressure regulator in accordance with claim 6 wherein the outer wall has a second channel formed therein.

9. The pressure regulator in accordance with claim 8 including a locking ring.

10. The pressure regulator in accordance with claim 8 wherein the locking ring has a compressed helical shape that engages the second channel.

11. The pressure regulator in accordance with claim 9 wherein the locking ring is engaged with the second channel and wherein the locking ring has an outer diameter that is greater than the inner diameter of the adjusting collar.

12. The pressure regulator in accordance with claim 1 wherein the adjusting collar has a ring with a shoulder, and an intermediate portion between the adjusting collar thread and shoulder.

13. The pressure regulator in accordance with claim 11 wherein the intermediate portion and the adjusting collar thread have a diameter less than a diameter of the shoulder.

14. A pressure regulator for controlling the flow of gas from a high pressure source to a low pressure device, comprising:
a body having a high pressure inlet defining a seat;
a guide sleeve, the guide sleeve formed as part of the body, the guide sleeve extending from around a plug chamber into a piston chamber, the guide sleeve having an inner and an outer wall;
the outer wall of the guide sleeve having a first channel continuously around the perimeter;
the outer wall of the guide sleeve having a second channel continuously around its perimeter;
an adjusting collar having a centrally located bore, the adjusting collar engaging the body at any predefined radial orientation, the adjusting collar having an adjusting collar thread thereon and securable to the body at the predefined radial orientation and at a fixed longitudinal location, the adjusting collar positioned adjacent to the second channel;
a plurality of fasteners for securing the adjusting collar to the body at the selected radial orientation, wherein the plurality of fasteners impart a radial force to secure the adjusting collar to the body;
a bonnet having a thread thereon, wherein the bonnet engages the adjusting collar;
a locking ring positioned in the second channel;
a piston having a central bore in a longitudinal direction that is disposed within a piston chamber, the piston chamber defining a gap between the piston and a wall wherein the piston is movable between an open condition and a closed condition;
a spring configured to move the piston to the open condition; and
a pin valve disposed within the central longitudinal bore in the piston.
